(19) United States
(12) Patent Application Publication
(10) Pub. No.: US 2016/0144890 A1
(43) Pub. Date: May 26, 2016

(54) STEERING CONTROL METHOD AND APPARATUS FOR STEER-BY-WIRE SYSTEM

(71) Applicant: HYUNDAI MOTOR COMPANY, Seoul (KR)

(72) Inventors: Jong Min KIM, Gwangmyeong-si (KR); Soo Bo PARK, Hwaseong-si (KR)

(21) Appl. No.: 14/712,581

(22) Filed: May 14, 2015

(30) Foreign Application Priority Data
Nov. 24, 2014 (KR) 10-2014-0164201

(51) Int. Cl. B62D 6/00; B62D 5/04; B62D 3/12; B62D 6/08; B62D 6/02

(52) U.S. Cl. CPC B62D 6/002; B62D 6/08; B62D 6/02; B62D 3/12; B62D 5/04

(57) ABSTRACT

A steering control method for a steer-by-wire (SBW) system includes receiving an output value reflecting a current steering wheel state and a current driving state of a vehicle. A current Ackerman effect value of the vehicle is determined according to the output value. If the current Ackerman effect value is different from an optimum Ackerman effect value which is determined according to the output value, toe angles of right and left wheels are changed and controlled such that the current Ackerman effect value becomes the optimum Ackerman effect value.

### CROSS REFERENCE TO RELATED APPLICATION

The present application claims the benefit of priority to Korean Patent Application Number 10-2014-0164201 filed on Nov. 24, 2014, the entire contents of which application are incorporated herein for all purposes by this reference.

### TECHNICAL FIELD

The present disclosure relates to a steering control technology for a steer-by-wire (SBW) system, and more particularly, to steering control method and apparatus for an SBW system capable of improving steering performance by changing an Ackerman effect according to a behavior of a vehicle.

### BACKGROUND

A steering apparatus of a vehicle allows a driver to select and control a direction in which the vehicle moves. The steering apparatus includes a steering wheel that is manipulated by the driver and a steering mechanism delivering a direction in which and a force by which the steering wheel is manipulated to wheels of the vehicle.

Power steering was developed and distributed to help drivers steer by augmenting the steering force of the steering wheel. Current power steering systems include a hydraulic type using hydraulic pressure, an electric-hydraulic type using both hydraulic pressure and electric power of a motor, an electric type using only the electric power of a motor, etc.

Recently, steer-by-wire (SBW) systems have been developed and used, which steers a vehicle using an electric motor. Mechanical connecting devices, such as a steering column, a universal joint, and a pinion shaft, between the steering wheel and wheels were eliminated

In particular, an independent-type SBW system includes a right wheel steering unit and a left wheel steering unit operating independently of each other without a mechanical connection therebetween. This system has advantages in that the number of parts and weight are reduced. In addition, a right wheel steering motor or a left wheel steering motor can be selectively operated to improve fuel efficiency.

FIG. 1 schematically illustrates a configuration of an SBW system of the related art. A reaction motor 3 is disposed on a steering column in order to augment a steering force of a steering wheel 1 applied by a driver. Right and left wheels 4 are divided independently of each other, and are respectively connected to rack bars 6 by means of tie rods 5. The rack bars 6 are respectively connected to steering motors 7 such that the rack bars 6 can linearly move using a rotational power received from the steering motors 7.

In addition, each of the reaction motor 3 and the steering motors 7 is connected to an output terminal of an SBW controller 8, and selectively operates in response to a control signal applied from the SBW controller 8.

However, in the above-described related art, the steering motors 7 are used only for augmenting the steering force of the steering wheel 1, and the right and left steering motors 7 must control rack stroke by the same amount.

Therefore, the same Ackerman effect is maintained over the entire driving range of a vehicle. It is therefore difficult to improve the steering performance using the steering motors.

The information disclosed in the Background section is only for the enhancement of understanding of the background of the disclosure, and should not be taken as an acknowledgment or as any form of suggestion that this information forms a prior art that would already be known to a person skilled in the art.

### SUMMARY

The present disclosure has been made keeping in mind the above problems occurring in the related art, and the present disclosure is intended to propose a steering control method and apparatus for a steer-by-wire (SBW) system able to improve steering performance by changing the Ackerman effect according to a behavior of a vehicle.

According to one aspect of the present inventive concept, a steering control method for an SBW system includes receiving an output value reflecting a current steering wheel state and a current driving state of a vehicle. A current Ackerman effect value of the vehicle is determined according to the output value. I If the current Ackerman effect value is different from an optimum Ackerman effect value which is determined according to the output value, toe angles of right and left wheels are changed and controlled such that the current Ackerman effect value becomes the optimum Ackerman effect value.

The output value may be a steering angle and a vehicle speed of a steering wheel.

At the step of changing and controlling the toe angles, the toe angles of the right and left wheels may be changed independently of each other.

At the step of changing and controlling the toe angles, the toe angles of the right and left wheels are changed to different angles.

At the step of changing and controlling the toe angles, the toe angles of the right and left wheels may be changed by adjusting an amount of a rack stroke through operation of actuators provided on the right and left wheels.

According to one aspect of the present inventive concept, a steering control apparatus for a steer-by-wire system includes a controller. The controller receives an output value reflecting a current steering wheel state and a current driving state of a vehicle, determines a current Ackerman effect value of the vehicle according to the output value. If the current Ackerman effect value is different from an optimum Ackerman effect value which is determined according to the output value, toe angles of right and left wheels are changed and controlled such that the current Ackerman effect value becomes the optimum Ackerman effect value.

According to the present disclosure as set forth above, steering is controlled by properly changing the Ackerman effect according to the driving state of the vehicle, it is possible to reduce a minimum turning radius of the vehicle and improve responsiveness and low-speed restoration.

### BRIEF DESCRIPTION OF THE DRAWINGS

The above and other objects, features and advantages of the present disclosure will be more clearly understood from the following detailed description when taken in conjunction with the accompanying drawings.

FIG. 1 schematically illustrates the configuration of an SBW system of the related art.

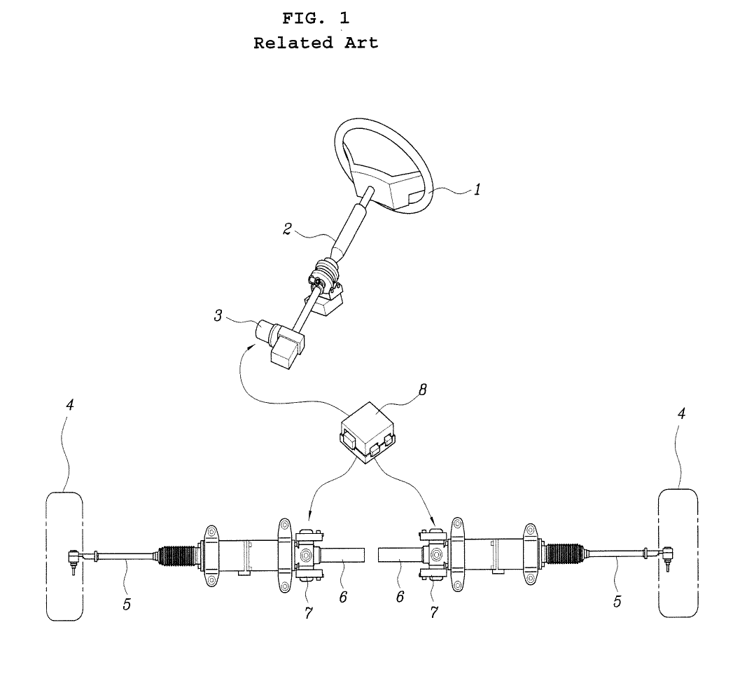

FIG. 2 is a flowchart illustrating the steering control flow of an SBW system according to an exemplary embodiment of the present inventive concept.

### DETAILED DESCRIPTION

Reference will now be made in greater detail to an exemplary embodiment of the present inventive concept, examples of which are illustrated in the accompanying drawings. Wherever possible, the same reference numerals will be used throughout the drawings and the description to refer to the same or like parts.

A steering control method for a steer-by-wire (SEW) system according to an exemplary embodiment of the present inventive concept includes an input step S10, a determination step S20 and a variable control step S30.

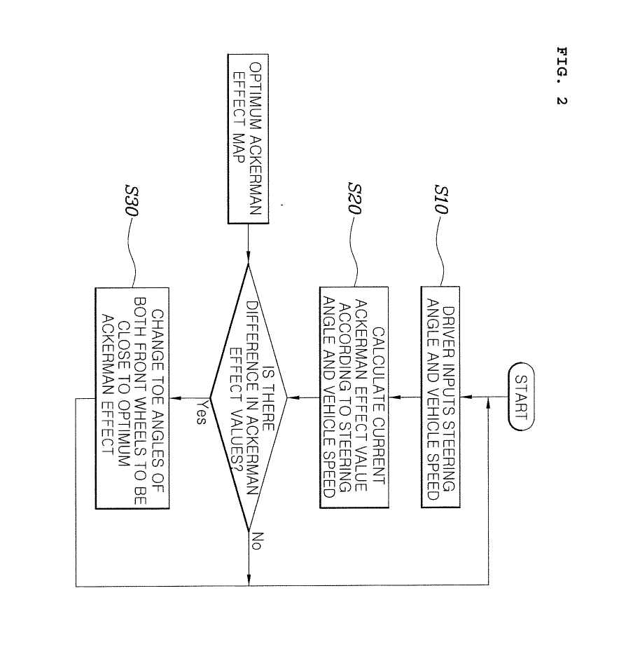

Describing the present disclosure in detail with reference to FIG. 2, at the input step S10, an output value reflecting a current steering wheel state and a current driving state of a vehicle are input.

For example, the output value reflecting the current steering wheel state may be a steering angle, which can be input through a steering wheel sensor. In addition, the output value reflecting the driving state may be a vehicle speed, which can be input through a vehicle speed sensor.

The determination step S20 determines a current Ackerman effect value of the vehicle according to the output value.

For example, the Ackerman effect value is determined based on the geometry of the vehicle. The Ackerman effect value may be obtained through calculation or as a table value.

The variable control step S30 includes setting an optimum Ackerman effect map using the output value reflecting the steering wheel state and the driving state of the vehicle. The current Ackerman effect value is compared with an optimum Ackerman effect value in the optimum Ackerman effect map to determine whether or not there is a difference between the current Ackerman effect value and the optimum Ackerman effect value. Here, the output value may be the steering angle and the vehicle speed, as described above.

If the current Ackerman effect value is different from the optimum Ackerman effect value as a result of the determination, a toe angle of either a right or left wheel is changed such that the current Ackerman effect value becomes equal to the optimum Ackerman effect value. If there is no difference, the current Ackerman effect value is left as it is.

For example, the present disclosure is applicable to an SBW system in which actuators (steering motors) are respectively disposed on right and left front wheels. It is possible to change a toe angle of each wheel by adjusting rack stroke, thereby independently adjusting the toe angle of each front wheel.

In particular, the toe angles of the right and left front wheels may be adjusted to be the same or different from each other using the actuators that operate independently of each other as described above, and thus the Ackerman effect value may be reliably adjusted.

In addition, a steering control apparatus for a steer-by-wire (SBW) system according to an exemplary embodiment of the present inventive concept may control steering using a controller.

For example, the controller receives an output value reflecting the current steering wheel state and the current driving state of the vehicle, and determines the current Ackerman effect value according to the output value.

It is possible to determine whether or not there is a difference between the current Ackerman effect value and the optimum Ackerman effect value using an optimum Ackerman effect map set according to the output value reflecting the current steering wheel state and the current driving state of the vehicle. If the current Ackerman effect value is different from the optimum Ackerman effect value, steering is controlled by adjusting the toe angles of the right and left front wheels such that the current Ackerman effect value follows the optimum Ackerman effect value.

Describing the steering control method according to the present disclosure in more detail, when the steering angle of the steering wheel is input in response to the driver manipulating the steering wheel at S10, the controller calculates the current Ackerman effect value of the vehicle according to the steering angle at S20. For example, when the steering angle is 138°, the current Ackerman effect value of the vehicle is 24%.

In the optimum Ackerman effect map, optimum Ackerman effect values are determined according to steering angle and vehicle speed conditions. The current Ackerman effect value is compared with the optimum Ackerman effect value in the optimum Ackerman effect map to determine whether or not the current Ackerman effect value is different from the optimum Ackerman effect value.

If it is determined that there is a difference, the toe angles of the right and left front wheels are adjusted by independently operating the actuators provided on the right and left front wheels such that the current Ackerman effect value becomes close to the optimum Ackerman effect value at S30.

As set forth above, the present disclosure improves the steering performance by changing the Ackerman effect according to a behavior of the vehicle.

When the vehicle runs at a high speed, a low Ackerman effect or high Ackerman effect may be advantageous in terms of a maximum lateral acceleration and reactivity. When the vehicle runs at a low speed, a high Ackerman effect is proven advantageous for restoration.

Accordingly, when steering is controlled by properly changing the Ackerman effect according to the driving state of the vehicle, it is therefore possible to reduce a minimum turning radius of the vehicle and improve responsibility and low-speed restoration.

Although the exemplary embodiments of the present inventive concept have been described for illustrative purposes, those skilled in the art will appreciate that various modifications, additions and substitutions are possible, without departing from the scope and spirit of the present disclosure as disclosed in the accompanying claims.

What is claimed is:

1. A steering control method for a steer-by-wire system, the method comprising steps of:
receiving an output value reflecting a current steering wheel state and a current driving state of a vehicle;
determining a current Ackerman effect value of the vehicle according to the output value; and
changing and controlling toe angles of right and left vehicle wheels such that the current Ackerman effect value becomes an optimum Ackerman effect value if the current Ackerman effect value is different from the optimum Ackerman effect value which is determined according to the output value.

2. The steering control method according to claim 1, wherein the output value comprises a steering angle and a vehicle speed of a steering wheel.

3. The steering control method according to claim 2, wherein the step of changing and controlling the toe angles comprises changing the toe angles of the right and left vehicle wheels independently of each other.

4. The steering control method according to claim 3, wherein the step of changing and controlling the toe angles is able to adjust the toe angles of the right and left wheels to different angles.

5. The steering control method according to claim 4, wherein the step of changing and controlling the toe angles comprises changing the toe angles of the right and left wheels by adjusting an amount of a rack stroke by actuators provided on the right and left vehicle wheels.

6. The steering control method according to claim 1, wherein the step of changing and controlling includes setting an optimum Ackerman effect map using the output value reflecting the steering wheel state and the driving state of the vehicle.

7. The steering control method according to claim 6, the current Ackerman effect value is compared with the optimum Ackerman effect value in the optimum Ackerman effect map to determine whether or not the current Ackerman effect value and the optimum Ackerman effect value are different from each other.

8. The steering control method according to claim 6, in the optimum Ackerman effect map, the optimum Ackerman value is determined according to the steering angle and the vehicle speed.

9. A steering control apparatus for a steer-by-wire system comprising a controller, wherein the controller receives an output value reflecting a current steering wheel state and a current driving state of a vehicle, determines a current Ackerman effect value of the vehicle according to the output value, and if the current Ackerman effect value is different from an optimum Ackerman effect value which is determined according to the output value reflecting the current steering wheel state and the current driving state of the vehicle, changes and controls toe angles of right and left vehicle wheels such that the current Ackerman effect value becomes the optimum Ackerman effect value.
